(19) United States
(12) Patent Application Publication
(10) Pub. No.: US 2003/0072351 A1
(43) Pub. Date: Apr. 17, 2003

(54) Temperature-sensing device of mobile terminal

(75) Inventor: Min-Yup Shin, Seoul (KR)

Correspondence Address: JONATHAN Y. KANG, ESQ., LEE & HONG P.C., 11th Floor, 221 N. Figuero Street, Los Angeles, CA, 90012-2601, US

(73) Assignee: LG Electronics Inc.

(21) Appl. No.: 10/214,032

(22) Filed: Aug. 7, 2002

(30) Foreign Application Priority Data
Oct. 13, 2001 (KR) 63225/2001

(51) Int. Cl. G01K 7/00

(52) U.S. Cl. 374/179; 374/178

(57) ABSTRACT

A temperature-sensing device of a mobile terminal is provided. The device comprises a pulse amplitude module (PAM), a mobile station modem (MSM) having ground and temperature-sensing terminals for controlling the PAM, and an electrical circuit. The circuit comprises first and second conductors, each having first and second ends. The first end of the first conductor is connected to the ground terminal, the first end of the second conductor is connected to the temperature-sensing terminal, and the second ends of the first and second conductors are connected to each other to form a junction. With the conductors oppositely charged and the junction situated adjacent to the PAM, the temperature difference between the junction and the MSM generates an electromotive force due to the Seebeck effect. This generates a potential difference between the ground and temperature-sensing terminals from which the MSM is then able to determine the temperature of the PAM as well as generate a signal to control the temperature of the PAM.

### CROSS REFERENCE TO RELATED APPLICATION

Pursuant to 35 U.S.C. §119(a), this application claims the benefit of earlier filing date and right of priority to the Korean Patent Application No. 2001-63225, filed on Oct. 13, 2001, entitled “Temperature-sensing Apparatus of Mobile Terminal,” the content of which is hereby incorporated by reference in its entirety.

### BACKGROUND OF THE INVENTION

1. Field of the Invention

The present invention relates to a mobile terminal in a mobile communication system, and more particularly, to a temperature-sensing device of a mobile terminal.

2. Description of the Background Art

FIG. 1 illustrates an internal block diagram of a mobile terminal adopting a conventional temperature-sensing device. A thermistor 11, which is a semiconductor composed of a mixture and/or sintering of oxides (such as manganese, nickel, copper, cobalt chrome, and ferrite) and is sensitive to variation in temperature, is used as temperature sensor of various instruments or as a temperature-compensating device of an electronic circuit. In the mobile terminal of FIG. 1, the thermistor 11 is placed near a pulse amplitude module (PAM) 1 to detect its temperature. A mobile station modem (MSM) 12 then compensates the temperature of the PAM1 on the basis of the detected temperature. However, the thermistor 11 in this case is installed at a distance from the PAM 1 and, therefore, a temperature difference may exist between the PAM 1 and the thermistor 11. Consequently, inaccurate temperature readings may occur and over or under compensation by the MSM 12 may result.

Although it has been considered to position the thermistor 11 and the PAM 1 in closer proximity to each other to overcome this problem concerning temperature inaccuracy, a difficulty lies in trying to locate the thermistor 11 close to the PAM 1 in terms of designing a printed circuit board (PCB). Various devices such as switches, power source(s), etc. for driving the PAM 1, which are inevitably situated around the PAM 1, prevent the positioning of the thermistor 11 closer to the PAM 1. As a result, accurate measurements of the temperature of the PAM 1 are difficult to obtain. Accordingly, the reliability of the power loss compensation control performed on the basis of the temperature of the PAM is degraded.

### SUMMARY OF THE INVENTION

The present invention is directed to a temperature-sensing device of a mobile terminal. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

A temperature-sensing device of a mobile terminal, according to one aspect of an embodiment of the invention, comprises a pulse amplitude module (PAM), a mobile station modem (MSM) a ground terminal and a temperature-sensing terminal for controlling the PAM; and an electrical circuit. The circuit comprises a first conductor having first and second ends, wherein the first end of the first conductor is connected to a ground terminal of the MSM, and a second conductor having first and second ends, wherein the first end of the second conductor is connected to a temperature-sensing terminal of the MSM and the second end of the second conductor is connected to the second end of the first conductor, forming a junction. According to one aspect of this embodiment, the conductors may be oppositely charged and comprised of metal. In addition, the junction may be situated adjacent to the PAM.

In some embodiments, an electromotive force is determined and generated by a temperature difference between the junction and the MSM as a result of a Seebeck effect. The MSM may then measure a potential difference between the ground terminal and the temperature-sensing terminal in order to determine temperature of the PAM and generate a PAM control signal to control the temperature of the PAM.

A method for controlling temperature in a mobile terminal, according to one aspect of the invention, comprises situating a junction of a first and second conductors adjacent to a PAM, wherein the first and second conductors are connected to a ground terminal and a temperature-sensing terminal of a MSM, respectively; measuring a potential difference between the ground terminal and the temperature-sensing terminal of the MSM, due to a temperature difference between the junction and the MSM; and generating a PAM control signal to control the temperature of the PAM. The conductors may be oppositely charged, due to the temperature difference between the junction and the MSM, and be comprised of metal. In addition, the temperature difference between the junction and the MSM may result in a potential difference between the ground terminal and the temperature-sensing terminal of the MSM due to a Seebeck effect. The temperature of the PAM may be determined from this potential difference.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 illustrates an internal block diagram of a mobile terminal employing a temperature-sensing device in accordance with the conventional art;

FIG. 2A illustrates a diagram of a Seebeck effect in accordance to one or more embodiments of the present invention;

FIG. 2B illustrates a circuit diagram of a temperature-sensing device according to one or more embodiments of the present invention; and

FIG. 3 illustrates an internal block diagram of a mobile terminal employing a temperature-sensing device in accordance with one or more embodiments of the present invention.

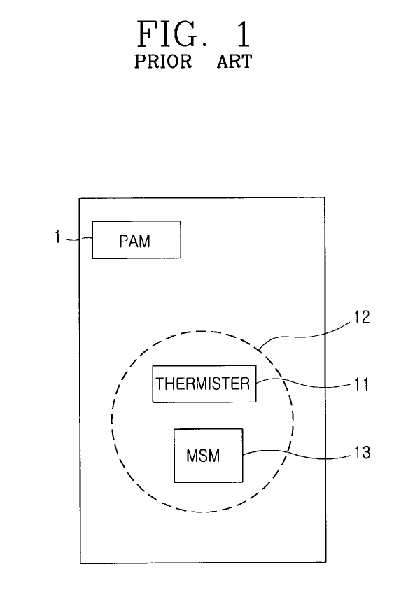

Features, elements, and aspects of the invention that are referenced by the same numerals in different figures represent the same, equivalent, or similar features, elements, or aspects in accordance with one or more embodiments.

Reference will now be made in detail to one or more embodiments of the invention, examples of which are illustrated in the accompanying drawings.

### DETAILED DESCRIPTION OF THE PREFERRED EMBODIMENTS

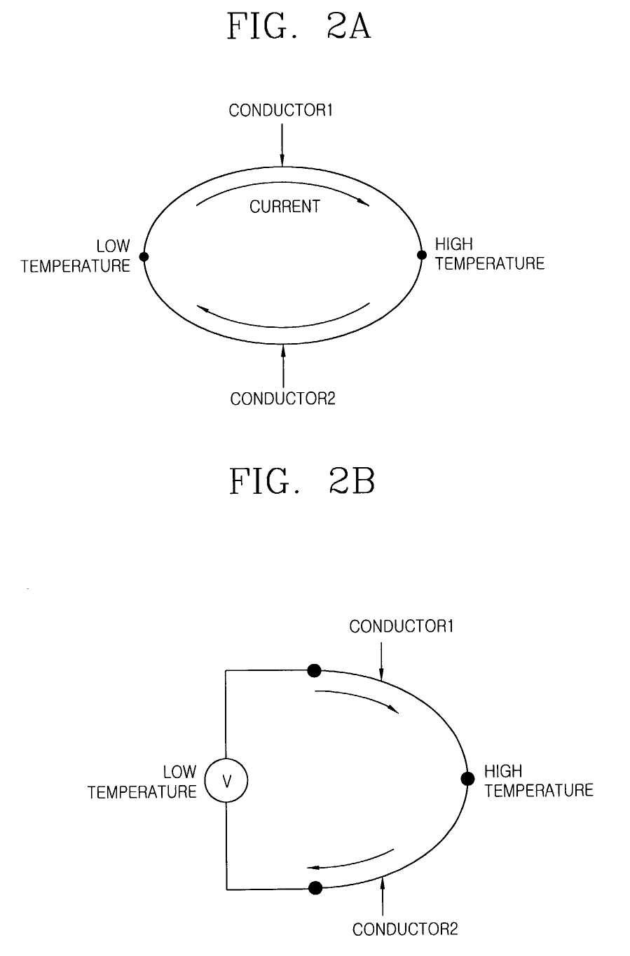

FIG. 2A illustrates a diagram of a Seebeck effect according to one or more embodiments of the present invention. The Seebeck effect (discovered by T. J. Seebeck of Germany in 1821) is a phenomenon where a thermal electromotive force is generated when two different conductors, Conductor 1 and Conductor 2, are bonded to construct a circuit and a temperature difference exists between the two bonded junctions, such that regions Low Temperature and High Temperature are formed.

FIG. 2B illustrates a circuit diagram according to the present invention, which incorporates the Seebeck effect. In FIG. 2B, Conductor 1 and Conductor 2 are metal and P-type semiconductors, respectively. Due to the temperature difference between the High Temperature and Low Temperature junctions, a plurality of holes, as carrier, in Conductor 2 diffuse into the metal semiconductor Conductor 1 so as to generate an electric field such that an electric current is created between the two junctions resulting in a voltage difference.

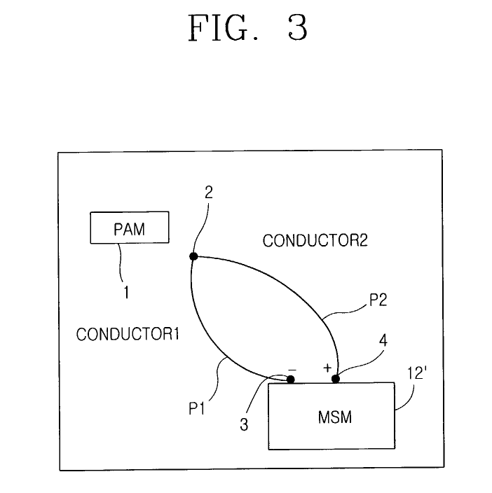

FIG. 3 is an internal block diagram of a temperature-sensing device of a mobile terminal in accordance with one more embodiments of the invention. The temperature-sensing device includes a first conductor P1 with one end connected to a ground terminal 3 of a MSM 12, and a second conductor P2 with one end connected to a temperature-sensing terminal 4 of the MSM 12. The conductors may be composed of metal, for example, or other conductive material. The second ends of P1 and P2 are bonded so as to form a junction 2 adjacent to a PAM 1 forming a closed circuit. Heat generated by PAM 1 is conducted to the junction 2, where P1 is negatively charged and P2 is positively charged.

Hereinafter, operation of the present invention will be described with reference to FIGS. 2B and 3.

When the mobile terminal transmits signals through an antenna, the PAM 1 generates heat during operation. The heat is conducted to the junction 2 of the first and second metal conductors P1 and P2 adjacent to the PAM 1. As such, a temperature difference is created between the junction 2 and the MSM 12. This temperature difference generates an electromotive force in the closed circuit, which consists of P1, P2, the junction 2 and the MSM 12, as a result of the Seebeck effect. Consequently, a potential difference dependent upon the temperature difference between the junction 2 and the MSM 12 is created between the ground terminal 3 and the temperature-sensing terminal 4 of the MSM 12. The MSM 12 then measures the potential difference between the ground terminal 3 and the temperature-sensing terminal 4 and calculates a temperature of the PAM 1 and generates a PAM control signal in order to control the temperature of the PAM 1. The present invention accurately measures the temperature of the mobile terminal and can be cost effectively manufactured due to ease of installation and greater utilization of space on the printed circuit board for various components of the mobile terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A temperature-sensing device of a mobile terminal comprising:
a pulse amplitude module (PAM);
a mobile station modem (MSM) having a ground terminal and a temperature-sensing terminal for controlling the PAM; and
a circuit comprising
a first conductor having first and second ends, wherein the first end of the first conductor is connected to the ground terminal of the MSM; and
a second conductor having first and second ends, wherein the first end of the second conductor is connected to the temperature-sensing terminal of the MSM and the second end of the second conductor is connected to the second end of the first conductor, forming a junction.

2. The temperature-sensing device of claim 1, wherein the first and second conductors are comprised of metal.

3. The temperature-sensing device of claim 1, wherein the junction is situated adjacent to the PAM.

4. The temperature-sensing device of claim 3, wherein the first conductor is negatively charged if heat is applied to the junction.

5. The temperature-sensing device of claim 3, wherein the second conductor is positively charged if heat is applied to the junction.

6. The temperature-sensing device of claim 3, wherein the first and second conductors are oppositely charged when heat is applied to the junction.

7. The temperature-sensing device of claim 3, wherein an electromotive force determined and generated by a temperature difference between the junction and the MSM is provided as a result of the Seebeck effect.

8. The temperature-sensing device of claim 7, wherein the MSM measures a potential difference between the ground terminal and the temperature-sensing terminal in order to determine temperature of the PAM.

9. The temperature-sensing device of claim 8, wherein the MSM generates a PAM control signal to control the temperature of the PAM.

10. A temperature-sensing device of a mobile terminal comprising:
a pulse amplitude module (PAM);
a mobile station modem (MSM) having a ground terminal and a temperature-sensing terminal for controlling the PAM; and
a circuit comprising
a first metal conductor having first and second ends, wherein the first end of the first conductor is connected to a ground terminal of the MSM; and
a second metal conductor having first and second ends, wherein the first end of the second conductor is connected to a temperature-sensing terminal of the MSM and the second end of the second conductor is connected to the second end of the first conductor, forming a junction situated adjacent to the PAM.

11. The temperature-sensing device of claim 10, wherein the first metal conductor is negatively charged if heat is applied to the junction.

12. The temperature-sensing device of claim 10, wherein the second metal conductor is positively charged if heat is applied to the junction.

13. The temperature-sensing device of claim 10, wherein the first and second metal conductors are oppositely charged if heat is applied to the junction.

14. The temperature-sensing device of claim 10, wherein an electromotive force determined and generated by a temperature difference between the junction and the MSM is provided as a result of the Seebeck effect.

15. The temperature-sensing device of claim 14, wherein the MSM measures a potential difference between the ground terminal and the temperature-sensing terminal in order to determine temperature of the PAM.

16. The temperature-sensing device of claim 15, wherein the MSM generates a PAM control signal to control the temperature of the PAM.

17. A method for controlling temperature in a mobile terminal comprising:
situating a junction of a first and second conductors adjacent to a PAM, wherein the first and second conductors are connected to a ground terminal and a temperature-sensing terminal of a MSM, respectively;
measuring a potential difference between the ground terminal and the temperature-sensing terminal of the MSM, due to a temperature difference between the junction and the MSM; and
generating a PAM control signal to control the temperature of the PAM.

18. The method of claim 17, wherein the first and second conductors are oppositely charged, due to the temperature difference between the junction and the MSM.

19. The method of claim 17, wherein the first and second conductors are comprised of metal.

20. The method of claim 17, wherein the temperature difference between the junction and the MSM results in a potential difference between the ground terminal and the temperature-sensing terminal of the MSM due to a Seebeck effect.

21. The method of claim 17, wherein the temperature of the PAM is determined from the potential difference.
